(19) United States
(12) Patent Application Publication
(10) Pub. No.: US 2014/0136425 A1
(43) Pub. Date: May 15, 2014

(54) FRAMEWORK FOR PROVDING ELECTRONIC LICENSES AND LICENSING PROGRAMS

(71) Applicant: Flexera Software LLC, San Jose, CA (US)

(72) Inventors: Vikram Venkata Koka, Fremont, CA (US); Ann Shvarts, San Jose, CA (US)

(73) Assignee: Flexera Software LLC, San Jose, CA (US)

(21) Appl. No.: 14/161,477

(22) Filed: Jan. 22, 2014

Related U.S. Application Data
(63) Continuation of application No. 13/552,609, filed on Jul. 18, 2012.

(51) Int. Cl. G06Q 50/18; G06Q 10/00

(52) U.S. Cl. CPC G06Q 50/184; G06Q 10/00
USPC 705/310

(57) ABSTRACT

Methods and system for providing licensing programs are provided. The electronic license may specify a number of available licenses based on the count property, a license model for calculating a number of used licenses based on the count type property, a number of available overdraft licenses based on the overdraft property, and an interval of available time within which return of a used license is accepted, which is based on the return interval property. The electronic license may then be distributed together with the licensing program to the licensee. A new electronic license can be deployed by the licensee without a need to update previously installed licensing program. The combination of count-related license properties may be applicable to a great variety of license models and deployments.

### CROSS-REFERENCE TO RELATED APPLICATIONS

The present application is a continuation of and claims the priority benefit of U.S. patent application Ser. No. 13/552,609 filed Jul. 18, 2012, the disclosure of which is incorporated herein by reference.

### BACKGROUND

1. Field of the Invention

The present invention generally relates to licensing. More specifically, the present invention relates to a framework for providing licensing programs.

2. Description of the Related Art

There are presently a variety of models for managing a licensed product or service (e.g., software-as-a-service). Such a license may be a digital or electronic license that enables functionality of the licensed product or service. In some instances, a user device may have a license pre-installed; alternatively, the user device may need to request a license. The particular model selected by a licensor (e.g., software publisher, service provider, device manufacturer) may vary based on their particular needs and the needs of their licensees. For example, one common model monitors a number of concurrent users. Concurrent users are those users that are using the licensed service at the same particular moment in time. For example, an enterprise customer may negotiate with a licensor (e.g., the software publisher, service provider, device manufacturer) so that one hundred enterprise employees are allowed to access the licensed service at a time. Under the concurrent model for licensing software, the number of users that may access the licensed software at the same time may be referred to as the count. The count may be capped with a predetermined limit or uncapped (e.g., generally a very large number).

In instances where the count is capped, the business may also wish to provide for overdraft licenses. An overdraft license may provide a licensed user access to the same service, though the pricing may negotiated differently. Where an overdraft license is available and the number of users meets the maximum count allowed under the license, any additional users may be considered to access the same service under an overdraft license. The availability of overdraft licenses allow for flexibility where a business may see only occasional spikes in usage. Such spikes may be rare enough that the business may not necessarily need to increase the count under the regular license. Access to the service may maintained in these rare occasions, however, with the availability of overdraft licenses. Similar to the count, the number of overdraft licenses may be capped or uncapped (e.g., a very large number). In instances where a business may not need continual access to the service, the count may be set to zero and all uses of the service may occur under overdraft licensing.

An alternative licensing model relies on metering or counting a total number of uses such that the licensee is billed for each use. Under such a metered model, the licensee may purchase a fixed number of total uses. For example, a business may pay for a hundred total licensed uses of a service. One difference between concurrent and metered model lies in how the count is calculated. As noted above, a concurrent count applies to a number of users using a service at a particular moment in time. A metered count applies to a total number of instances that the service was used. Similar to the concurrent count, a metered count may be zero, capped, or uncapped (e.g., a very large number), and overdraft licenses (capped or uncapped) may also be available.

One complication in the metered model is verifying that a use has occurred for the purpose of enforcing a capped count or billing the licensee. For example, there may be instances where a user may request a service, but not end up actually using the service. For example, a network connection may be interrupted or other failure may occur that prevents the user from using the licensed service. Services that involve a transaction may fail, be cancelled, or otherwise relinquished by the user before completion of the intended use. Depending on the particular service and attendant requirements, there may be a variety of reasons why an instance of access may not necessarily mean that the user received the benefit of such access. Since the enterprise customer may not have received the benefit of the use, that customer likely will not wish to be billed for the same. This creates accounting issues with respect to identifying contested uses and billing only for legitimate or completed uses. On the other hand, there could be metered licensing models where no return is allowed or only allowed within limited time interval.

Indeed, there are a great variety of licensing models that may be negotiated between a licensor and licensee. Presently, such licensing models are generally implemented and deployed through use of tools and software that are customized to the particular licensing model. As such, such licensing models may be inflexible to changes, as changes to the licensing model may require changes to the underlying tools and software. Because there is such a variety of possible licensing models that address different needs, the process of developing licensing programs for multiple licensors has been difficult and complicated to scale effectively or efficiently. There is a need for improved frameworks for providing licensing programs.

### SUMMARY OF THE CLAIMED INVENTION

Embodiments of the present invention include systems and methods for providing licensing programs are provided. Information is received concerning one or more licensing properties desired by a licensor. The licensing properties may concern count, count type, overdraft, and return interval. License information is used to generate an electronic license specific to the licensor and licensee contract This electronic license is then used by the licensing program that specifies a number of available licenses that is based on the count property, a license model (associated with one or more algorithms) for calculating a number of used licenses that is based on the count type property, a number of available overdraft licenses that is based on the overdraft property, and an interval of available time within which return of a used license is accepted, which is based on the return interval property. An accepted return of the used license may result in adjustment of the number of used licenses.

Various embodiments of the present invention include methods providing licensing programs. Such methods may include receiving information from a licensor concerning licensing properties concerning count, count type, overdraft, and return interval, storing license information associated with the licensor in memory, and executing instructions to generate an electronic license specific to the license information received from the user that can be used by the licensing program that specifies a number of available licenses that is based on the count property containing in the electronic license, a license model (associated with one or more algorithms) for calculating a number of used licenses that is based on the count type property, a number of available overdraft licenses that is based on the overdraft property, and an interval of available time within which return of a used license is accepted, which is based on the licensing property concerning return interval.

Embodiments of the present invention may further include systems for flexible licensing. Such systems may include a communications interface for receiving information concerning one or more desired licensing properties from a licensor concerning count, count type, overdraft, and return interval; memory for storing license information associated with the licensor and licensee contract; and a processor for executing instructions to generate an electronic license and licensing program that specifies a number of available licenses that is based on the count property contained in the electronic license, a license model (associated with one or more algorithms) for calculating a number of used licenses that is based on the count type property, a number of available overdraft licenses that is based on the overdraft property, and an interval of available time within which return of a used license is accepted, which is based on the licensing property concerning return interval.

Other embodiments of the present invention include non-transitory computer-readable storage media on which is embodied instructions executable to allow for providing electronic licenses and licensing programs in general accordance with the method previously set forth above.

### BRIEF DESCRIPTION OF THE DRAWINGS

FIG. 1A illustrates a network environment in which a system for providing licensing programs may be implemented.

FIG. 1B illustrates an alternative network environment in which a system for providing licensing programs may be implemented.

FIG. 1C illustrates another alternative network environment in which a system for providing licensing programs may be implemented.

FIG. 2 is a chart illustrating count-related licensing properties.

FIG. 3 is a flowchart illustrating a method for deploying a licensing program.

FIG. 4 is a flowchart illustrating another method for deploying a licensing program.

### DETAILED DESCRIPTION

Embodiments of the present invention include systems and methods for providing licensing programs are provided. Information is received information concerning one or more licensing properties desired by a licensor. The licensing properties may concern count, count type, overdraft, and return interval. License information is stored in memory regarding the licensing properties, which are then used by a licensing program specific to the licensor. The licensing program specifies a number of available licenses that is based on the count property, a license model (associated with one or more algorithms) for calculating a number of used licenses that is based on the count type property, a number of available overdraft licenses that is based on the overdraft property, and an interval of available time within which return of a used license is accepted, which is based on the return interval property. An accepted return of the used license may result in adjustment of the number of used licenses.

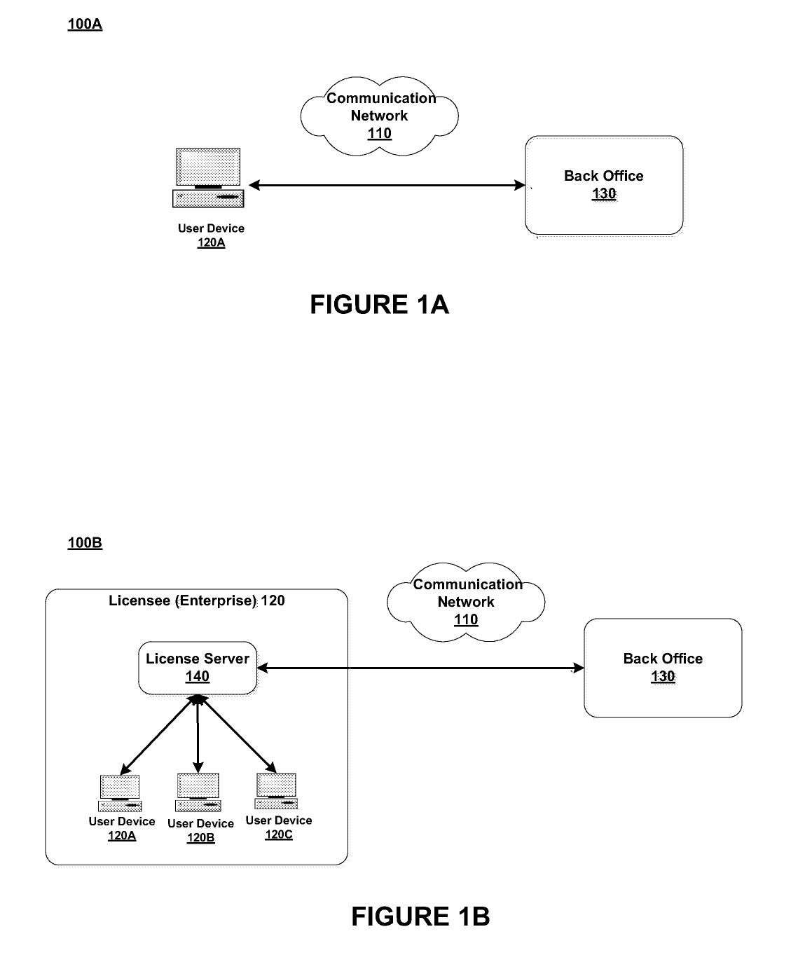

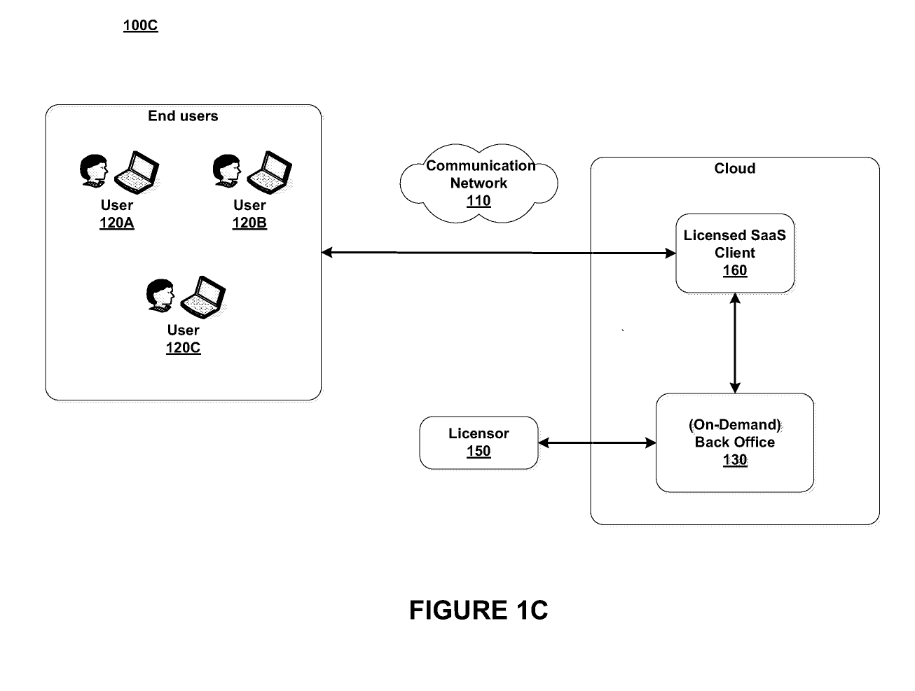

FIG. 1A illustrates a network environment 100A in which a system for providing licensing programs may be implemented. Network environment 100A may include a communication network 110, a customer (e.g., licensee) whose license may encompass one or more user devices (e.g., user device 120A), and a licensor back office 130. Devices in network environment 100A may communicate with the back office 130 via communications network 110.

Communication network 110 represents a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of network environments 100A-C.

A licensee may be an entity that includes one or more users associated with user devices 120. For example, a licensee may be an individual user or an enterprise encompassing multiple users. Such users may use any number of different electronic user devices 120A-C to access the licensed service, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network 110. User devices 120A-C may also be configured to access data from other storage media, such as memory cards or disk drives as may be appropriate in the case of downloaded services. User device 120A-C may include standard hardware computing components such as network and media interfaces, non-transitory computer-readable storage (memory), and processors for executing instructions that may be stored in memory. As used herein, user device 120 may also refer to client device software for implementing the various client device functions described herein.

Licensor back office 130 may include any type and number of servers or other computing devices known in the art, including standard hardware computing components such as network and media interfaces, non-transitory computer-readable storage (memory), and processors for executing instructions or accessing information that may be stored in memory. In some instances, the functionalities of multiple servers may be integrated into a single server. Any of the aforementioned servers (or an integrated server) may take on certain client-side, cache, or proxy server characteristics. These characteristics may depend on the particular network placement of the server or certain configurations of the server. As used herein, back office 130 may also refer to server software for implementing the various back office functions described herein.

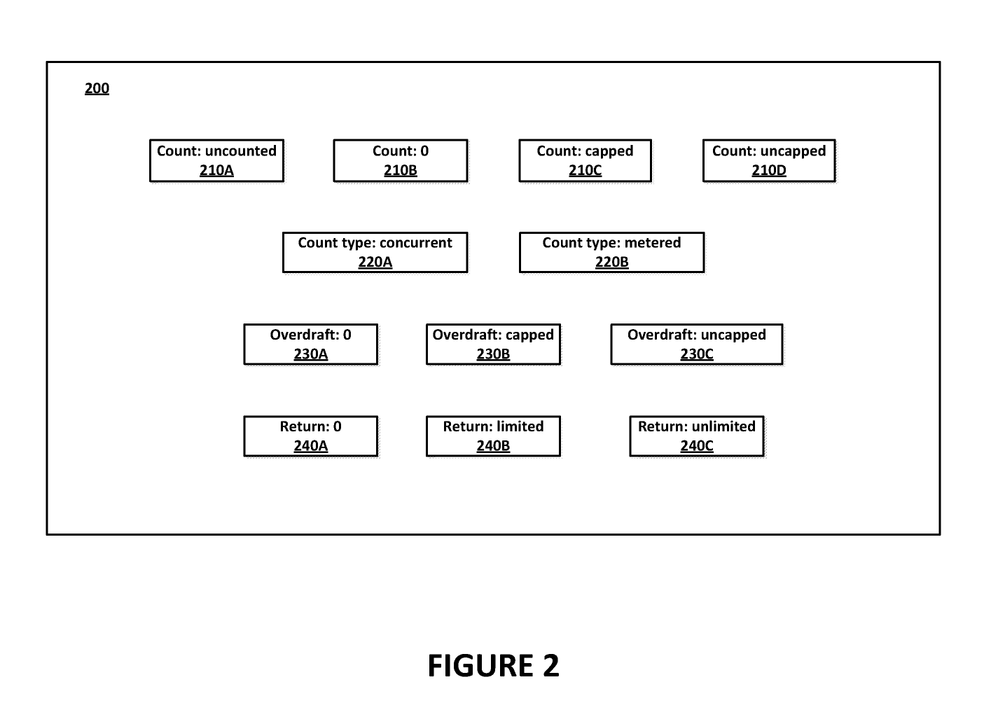

Back office 130 may generate, enforce, and/or provide usage information regarding licensing programs for particular licensors. In generating a licensing program for a licensor, the back office 130 may receive information regarding properties that are desired by the licensor. Such properties are illustrated in FIG. 2 and may include count 240A-D, count type 250A-B, overdraft 260A-C, and return interval 270A-C. The count property 240 may refer to a number of licenses available under the license (e.g., zero 240B, capped 240C, uncapped 240D). The count type property 250 may refer to how the count is calculated (e.g., concurrent 250A or metered 250B). The overdraft property 260 may refer to a number of overdraft licenses available (e.g., zero 260A, capped 260B, uncapped 260C); and the return interval property 270 may refer to an interval of time in which a license may be returned (e.g., zero 270A, limited 270B, unlimited 270C). Additional licensing properties may include information regarding third-party vendors, features, time-related properties (e.g., start and expiration dates), or serverability.

There may be default properties that apply where a licensor may not specify a specific preference. For example, the default count type may be concurrent, and the default overdraft property may be zero. In addition, some properties may only be available in combination. For example, a count property of zero only makes sense where there is a non-zero overdraft property count. Still other properties may only be available in the absence of another type of property. For example, a count property of uncounted is a special case where a count does not relate to the value of a licensed service. Uncounted licenses may exist where a user may just get a permission to use the capability of a device or a service. Because the use of the device or service is not measured, the uncounted property may not coexist with other count-related properties. Such (in)compatibility rules may be automatically applied as part of registration, sign-up, or provisioning process for the licensor. As such, an electronic license may be generated based on the designated properties. Unlike presently available licensing models that are generated on a customized basis, the framework described herein allows for a plurality of different licensing models and programs to be deployed, managed, and updated in a scalable manner.

Back office 130 may be associated with the licensor (e.g., software publisher, service provider, device manufacturer) or a third-party vendor (e.g., license manager, cloud-based services) that manages licensing for one or more licensors. In some embodiments, back office 130 may additionally include a number of databases, license servers, analytics modules, portals (e.g., for licensor or licensee), and various management tools. Such components may be housed together, separately, in various combinations, locally and/or remotely. Several different variations are illustrated in FIGS. 1A-C.

Back office 130 may additionally include databases for storing and updating information regarding a license contract between a licensor and licensee or license server(s) for managing any updates and changes to the license. In addition, where the back office 130 is associated with a third-party license manager, specialized interfaces or portals for communicating with other parties in the system (e.g., licensors, licensees) may also be included. In addition, back office 130 may include analytics modules for reviewing, analyzing, and generating various metrics and reports for particular licenses, licensors, or licensees. Such reports and notifications allow a licensor to provide usage based billing and a licensee to obtain granular data regarding its licensed uses. Depending on the preferences of the licensee, notifications may be sent when the number of license uses (or overdraft license uses) is nearing or has reached predetermined thresholds. Alternatively, the notifications may be sent where the number of available licenses (or overdraft licenses) has decreased to certain thresholds.

Network environments such as 100A may appear in enforcement deployments of licensing models where a capped count may be in place. In an exemplary enforcement deployment (either concurrent or metered), one of the user devices (e.g., 120A) submits a request for a licensed service to the back office 130, which is associated with the licensor (e.g., software publisher, service provider, device manufacturer) via communication network 110. The back office 130 may receive the request, determine whether applicable capped limit(s) (count or overdraft) have been met, and respond to the user device 120A. The response may provide a license or overdraft license under the applicable licensing program, access to the licensed product or service under the license, or denial of the requested license or access to the licensed product or service (e.g., where there are no available license or overdraft license uses available).

After electronic license is received by the device 120A, the licensing program running on the device can use the license to regulate the licensed functionality of the device. In particular, the capabilities available on the device will be limited by the license provided by the back office. Please note that this license can be modeled in a variety of ways based on the specifics of the licensor and licensee agreement and the licensing program running on the device 120 does not need to change to accommodate this variety.

FIG. 1B illustrates an alternative network environment 100B in which an alternative system for providing electronic licenses may be implemented. Like FIG. 1A, the illustrated network environment 100B includes a licensee 120 and a back office 130, which may be associated with the licensor (e.g., software publisher, service provider, device manufacturer), in communication via a communication network 110. Rather than a single user device (e.g., user device 120A of FIG. 1), the licensee in network environment 100B is, however, an enterprise having a plurality of users (e.g., user devices 120A-C). In addition, a license server 140, which may be associated with the enterprise licensee, may be included. Similar to the user device 120A and back office 130, license server 140 may be used to refer to an actual server or to license server software for implementing license server functions described herein.

Such a network embodiment 100B may exist in either enforcement or usage-based deployments. In an exemplary enforcement deployment, a license server 140 sends a license request to back office 130. Back office 130 provides the response to license server 140 to convey licenses allocated for the enterprise licensee. At this point, license server 140 can distribute licenses it received from the back office between user devices 120A-C. As such, license server 140 may act as intermediary for all user devices 120A-C associated with a licensee 120. In order to receive the license, the user device 120A may submit a request to license server 140. The license server 140 may use licensing algorithms and electronic license information received from the back office 130 to determine if the license is available for the user device 120A. In the enforcement model, it is possible that all the licenses are consumed by other devices, so the request for the license from the device 120A can be denied.

In a usage-based deployment, each user device 120A-C associated with licensee 120 may send reports regarding usage of the licensed service to license server 140, which may convey them to back office 130. Usage-based deployments may be used to allow for pay-per-use, which may exist where the count property or overdraft property may be uncapped. As such, the licensed service is never be denied, but usage reports may be necessary to determine how to bill the licensee. In addition, the license server 140 may send consolidated reports regarding the usage for all user devices 120A-C associated with the licensee 120.

The rule providing for either enforcement or usage-based deployment is defined in the electronic license itself via the count related properties described herein. As such, the underlying software framework (e.g., licensing program) running on the license server does not need to change to accommodate enforcement or usage-based licensing models.

FIG. 1C illustrates another alternative network environment 100C in which a system for providing licensing programs may be implemented. Like FIGS. 1A and 1B, the illustrated network environment 100C includes licensee end users and back office 130 in communication via a communication network 110. Network environment 100C may exist where a licensor allows for a third-party vendor (e.g., license manager, cloud service provider) to manage the licensing program. As such, network environment 100C may include the licensor 150 and the vendor, which may include a licensing SaaS client 160 that may be associated with back office 130. Under such a model, a user 120A may use the licensing SaaS client 160 to perform variety of licensed actions. The SaaS client may communicate with the back office to obtain the license information for the user 120A and grant or deny access to the licensed functionality based on the electronic license configured by the licensor for the licensee. Licensing SaaS client 160 may also provide reports to back office 130 about the usage of the licensed functionality by licensee. Reports specific to the needs of licensor 150 may be generated and provided by back office 130. In addition, licensor 150 may communicate (e.g., via a portal) with back office 130 to adjust any licensing properties as desired.

The network environments 100A-C illustrate just a few possible deployment of the electronic licenses and licensing program. Many other combinations are possible with various components being deployed locally or on-demand. In addition, electronic license can be used on disconnected device. For example, an electronic license can be preloaded on the user device by the manufacturer at the production time.

FIG. 2 is a chart 200 illustrating count-related licensing properties. While additional properties are possible, chart 200 lists various count-related licensing properties, including those that concern count 210A-D, count type 220A-B, overdraft 230A-C, and return interval 240A-C. The count property 210 may be used to determine a number of license uses available to a licensee. The count type property 220 may be used to determine what algorithms to use to calculate a number of license uses. Examples of count type include concurrent and metered. Concurrent algorithms may be used to calculate a current number of concurrent users, while metered algorithms may be used to calculate a current number of licenses that have been used. The overdraft property 230 may be used to determine a number of overdraft license uses that are available to the licensee. The return interval property 240 may be used to determine an interval of available time within which return of a used license is accepted. If the return of the used license is accepted, the number of used licenses may be adjusted. As noted above, there may be restrictions on what combinations of licensing properties are possible (e.g., some licensing properties may be incompatible).

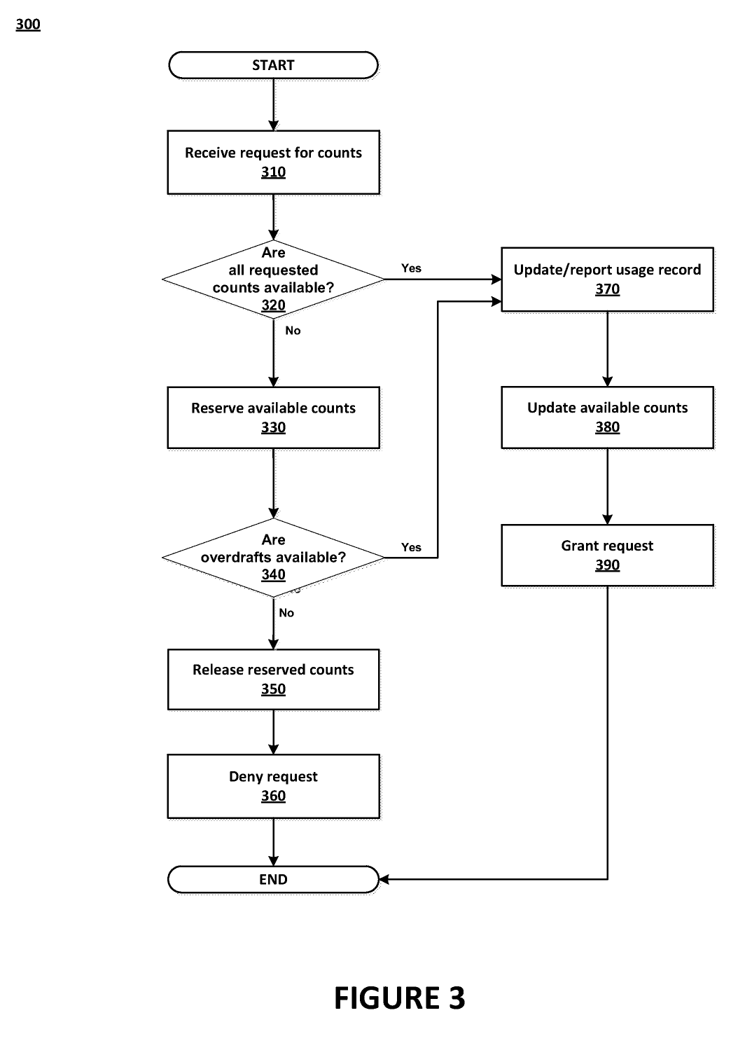

FIG. 3 illustrates a method 300 for deploying an exemplary licensing program. The method 300 of FIG. 3 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 3 (and the order thereof) are exemplary and may include various alternatives, equivalents, or derivations thereof including but not limited to the order of execution of the same.

In method 300 of FIG. 3, a request for a number of counts is received, and it is determined whether the requested number of counts is available. If the total number of requested counts is not available, any available counts may be reserved, and it is then determined whether any overdrafts are available. If there are no overdrafts available, the reserved counts are released, and the request is denied. Where the total number of requested counts and/or overdrafts is available, the usage record may be updated regarding the usage count and the time (and reported as desired). In addition, a number of available counts may be updated, and the license request may be granted.

In step 310, a request is received for a number of counts by a licensing program. Such a licensing program may use an electronic license based on a combination of the licensing properties in the chart of FIG. 2. Such a licensing program may pertain to a licensed product or service (e.g., software-as-a-service, platform-as-a-service) provided by a licensor (e.g., software publisher, service provider, device manufacturer) to their customers (licensees). Any type of software known in the art may be offered for licensing. The request may indicate that a number of users may wish to use the licensed product or service and/or that the users may want to consume a certain amount of product or service. As such, granting the request would entail deducting the number of granted license uses from the available count.

The request may be sent by a user or a user device (e.g., user device 120A) to a back office 130 or an intermediary (e.g., license server 140 or licensed SAAS client 160). Such request may include user information (or licensee information), which may be used to identify the user or the licensee associated with the user. For example, an employee (or client) of a particular licensee may send the request for access to a software service that has been licensed to licensee. Identifying or authenticating information may be included in the request that may be used to determine that the user is authorized under the customer license to access the requested software.

In step 320, it is determined whether all the requested counts are available. As noted above, the count property of a licensing program indicates a number of license uses currently available to the licensee. The requested counts may therefore be compared to information regarding the count property and/or usage. Where the requested counts are determined to be more than the number of available licenses (e.g., as indicated by count property), the method may proceed to step 330. Where it is determined that the requested counts are less than or equal to the number of available license uses, the method may proceed to step 370.

In step 330, any available counts may be reserved. Although not all requested counts are available, there may be some licenses available under the count property of the license. As such, the available counts may be reserved in order to fulfill at least part of the request. A remaining part of the request may need to be fulfilled by license uses under an overdraft provision of the license. Until the determination is made as to whether there are sufficient overdraft license uses to fulfill the request, the available license count may be reserved.

In step 340, it is determined whether overdraft license counts are available to fulfill the request. The determination may be based on information regarding the license overdraft property. Where there are no (or not enough) overdraft license uses available to fulfill the request, the method may proceed to step 350. Where there are sufficient overdraft license uses available to fulfill the request, the method may proceed to step 370.

In step 350, the reserved counts are released. Because there are insufficient licenses among counts and overdrafts to fulfill the request, even in combination, the request therefore cannot be fulfilled. As such, the reserved license uses may be released. In addition, the request is denied in step 360, which may prevent the user or the user device from using the requested licensed functionality. Alternatively, logic allowing for partial fulfillment of the license request can be implemented if required by licensor business logic.

In step 370, the usage record is updated with respect to the license use (and/or overdraft license use). In some instances, the licensing program may include uncapped count or uncapped overdraft, and the licensee may be billed based on pay-per-use. As such, usage information may be communicated to the licensor for the billing purposes. The usage information may also be maintained for the licensee so that the determination of how much uses occurred may be made and the billing information can be verified Additionally, the usage information may be reported periodically at predetermined interval and/or at predetermined thresholds to both licensor and licensee.

In steps 380 and 390, information regarding available count may be updated, and the request may be granted. Where there are capped counts (or capped overdrafts), usage affects the availability of the same. Availability information may be updated for use in evaluating subsequent requests. The grant of a request may allow the user or user device 120A to access the requested licensed functionality or service.

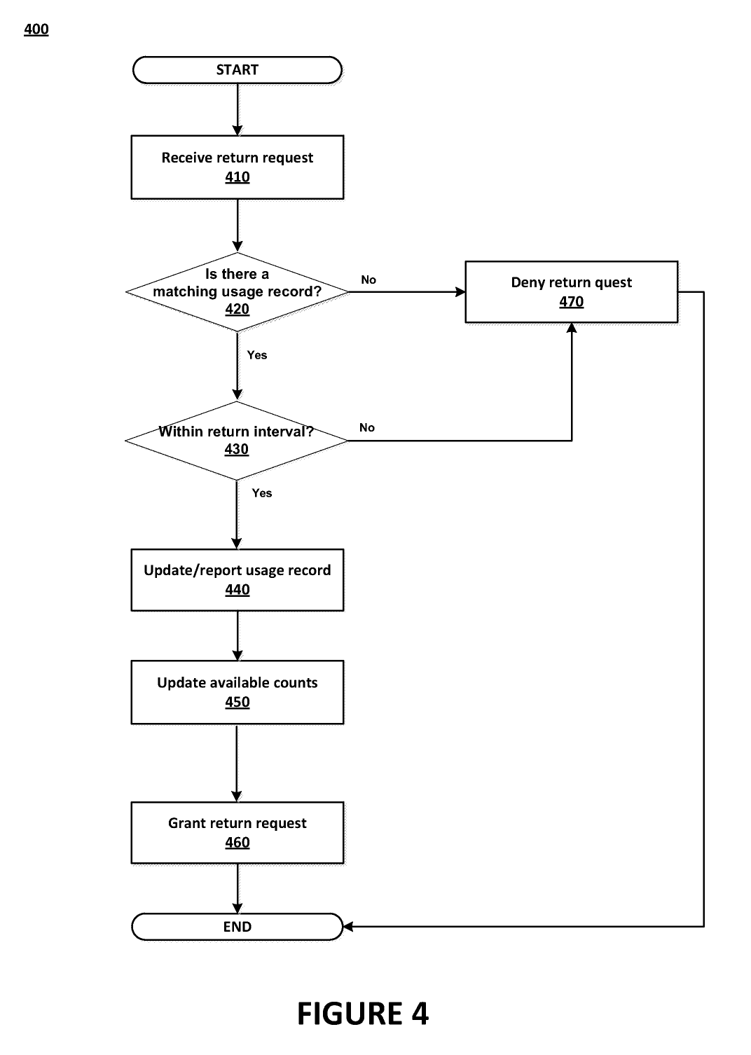

FIG. 4 illustrates another method 400 for deploying a licensing program. In method 400 of FIG. 4, a return request is received, and it is determined whether there is a matching usage record. If there is no usage record, the request may be denied. The request may also be denied if it is also determined that the request is not received within the allowed return interval indicated by the return interval property of the electronic license. If the request is received within the return interval, the usage record may be updated (and/or reported). Available counts may also be updated, and the return request granted.

In step 410, a request to return a license use may be received. Such a request may be received in instances of mistake or where the user may no longer need to use the licensed product or service. A user may erroneously submit a request to use the licensed product or service. In some instances, therefore, a licensing program may allow for an interval of time within which return may be allowed.

In step 420, it is determined whether there is a usage record that matches the return request. When a licensee uses the licensed product or service, a usage record may be updated to reflect the details of the usage, specifically used count and the time of transaction (e.g., step 370 of FIG. 3). As such, any return request should be associated with a corresponding usage record. Where there is no corresponding usage record, the method may proceed to step 470 in which the return request is denied. Where there is a corresponding usage record, the method may proceed to step 430.

In step 430, it is determined whether the request is received within a return interval of the applicable licensing program. The determination may be based on a times that the original and return requests were received and the return interval indicated by the return interval property of the license. If the return request was made within the return interval, the method may proceed to step 440. If the return request was not made within the return interval, the method may proceed to step 470 in which the return request is denied.

Steps 440 and 450 involve updating of the usage record and available counts. As explained above, the usage record reflects license uses by a licensee. In some instances, the usage record may further reflect returns (or reversals) of the license uses. Because usage may affects availability of counts in licensing programs with capped counts or overdrafts, the available counts may also be updated accordingly. In step 460, the return request may be granted.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for providing licensing programs, the method comprising:
storing information associated with a licensor in memory, the stored information including the received information regarding one or more desired licensing properties, the licensing properties selected from the group consisting of count, count type, overdraft, and return interval; and
executing instructions stored in memory, wherein execution of the instructions by a processor generates an electronic license specific to the information received from the user, wherein the electronic license specifies:
a number of licenses available to a licensee, wherein the number of available licenses is determined based on the licensing property concerning count,
a license model based on concurrent or metered use, wherein the license model is based on the licensing property concerning count type,
a number of overdraft licenses available to the licensee, wherein the number of available overdraft licenses is determined based on the licensing property concerning overdraft, and
an interval of available time within which return of a used license is accepted, wherein the interval of available time is determined based on the licensing property concerning return interval and wherein an accepted return of the used license results in adjustment of the number of used licenses.

2. The method of claim 1, wherein a license use by the licensee is associated with a deduction from the number of available licenses.

3. The method of claim 2, wherein the adjustment of the number of used licenses includes a reversal of the deduction from the number of available licenses.

4. The method of claim 1, wherein the number of licenses available to a licensee is capped, and wherein no additional license use is permitted when the number of available licenses is zero.

5. The method of claim 4, wherein the number of available licenses is zero, wherein use of an overdraft license is permitted when the number of available overdraft licenses is not zero, and wherein use of an overdraft license is associated with a deduction from the number of available overdraft licenses.

6. The method of claim 5, wherein the number of available overdraft licenses is capped, and wherein no additional overdraft license use is permitted when the number of available overdraft licenses is zero.

7. The method of claim 1, wherein the licensing property concerning count indicates that the number of available licenses is unlimited.

8. The method of claim 1, wherein the licensing property concerning overdraft indicates that the number of available overdraft licenses is unlimited.

9. The method of claim 1, wherein the license model based on concurrent use is associated with one or more algorithms for calculating the number of used licenses based on a number of concurrent license uses.

10. The method of claim 1, wherein the license model based on metered use is associated with one or more algorithms for calculating a number of used licenses based on a running total of license uses.

11. The method of claim 1, wherein the licensing property concerning return interval indicates that the interval of available time is unlimited and wherein return of a used license is accepted at any time.

12. The method of claim 1, wherein the licensing property concerning return interval indicates that the interval of available time is zero and wherein return of a used license is not accepted when the interval of available time is zero.

13. The method of claim 1, further comprising sending a notification to a designated recipient associated with the licensee when the number of available licenses or available overdraft licenses falls below a designated threshold or when a number of used licenses meets a designated threshold.

14. The method of claim 1, further comprising updating the stored usage records and generating a report for the licensor based on the updated usage data.

15. The method of claim 14, wherein a report is generated for the licensee.

16. A system for providing licensing programs, the system comprising:
memory for storing information associated with a licensor, the stored information including the received information regarding one or more desired licensing properties, the licensing properties selected from the group consisting of count, count type, overdraft, and return interval; and
a processor for executing instructions stored in memory, wherein execution of the instructions by the processor generates an electronic license specific to the information received from the user, wherein the electronic license specifies:
a number of licenses available to a licensee, wherein the number of available licenses is determined based on the licensing property concerning count,
a license model based on concurrent or metered use, wherein the license model is based on the licensing property concerning count type,
a number of overdraft licenses available to the licensee, wherein the number of available overdraft licenses is determined based on the licensing property concerning overdraft, and
an interval of available time within which return of a used license is accepted, wherein the interval of available time is determined based on the licensing property concerning return interval and wherein an accepted return of the used license results in adjustment of the number of used licenses.

17. The system of claim 16, further comprising a back office server associated with the licensor for generating and managing electronic licenses.

18. The system of claim 17, further comprising an intermediary license server that:
receives a set of licenses from the back office server to distribute to one or more clients associated with the licensee;
receives a request to use a license from a client associated with the licensee;
permits the requested license use when the set of licenses received from the back office server indicates that the number of available licenses is enough to satisfy the request, and
does not permit the requested license use when the back-end server indicates that the number of available licenses is insufficient.

19. The system of claim 16, further comprising a license server that:
records details of the usage events for the clients associated with the licensee, including a number of licenses used by the requesting client and a time of the license use; and
reports usage data to both the licensee and the licensor.

20. A non-transitory computer-readable storage medium, having embodied thereon a program executable by a processor to perform a method for providing licensing programs, the method comprising:
storing information associated with a licensor, the stored information including the received information regarding one or more desired licensing properties, the licensing properties selected from the group consisting of count, count type, overdraft, and return interval; and
generating an electronic license specific to the information received from the user, wherein the licensing program specifies:
a number of licenses available to a licensee, wherein the number of available licenses is determined based on the licensing property concerning count,
a license model based on concurrent or metered use, wherein the license model is based on the licensing property concerning count type,
a number of overdraft licenses available to the licensee, wherein the number of available overdraft licenses is determined based on the licensing property concerning overdraft, and
an interval of available time within which return of a used license is accepted, wherein the interval of available time is determined based on the licensing property concerning return interval and wherein an accepted return of the used license results in adjustment of the number of used licenses.
